(19) United States
(12) Patent Application Publication
(10) Pub. No.: US 2008/0043804 A1
(43) Pub. Date: Feb. 21, 2008

(54) IDENTIFICATION AND CONDITION DETECTION SYSTEM

(76) Inventors: Robert M. Goldsmith, Pasadena, CA (US); Brad Reddersen, Pasadena, CA (US)

Correspondence Address: PERKINS COIE LLP, POST OFFICE BOX 1208, SEATTLE, WA, 98111-1208, US

(21) Appl. No.: 11/838,727

(22) Filed: Aug. 14, 2007

Related U.S. Application Data
(60) Provisional application No. 60/822,616, filed on Aug. 16, 2006.

(51) Int. Cl. G01K 3/00

(52) U.S. Cl. 374/106; 116/207

(57) ABSTRACT

The present disclosure relates to a method for monitoring item sourcing and handling information. The present disclosure provides a device for tracking and tracing a product or item's source and handling history. The present disclosure may, for instance, be applied to any product that is packaged, distributed, shipped, or requiring or using cold chain distribution where a greater quality of freshness of a product is desired or where preventing distribution or removing from distribution of a product exposed to a preselected condition such as an undesirable environmental temperature is desired.

### PRIORITY CLAIM

This application claims the benefit of U.S. Provisional Patent Application Ser. No. 60/822,616, filed Aug. 16, 2006, which is incorporated herein by reference.

### FIELD OF THE DISCLOSURE

The present disclosure relates to product identification labeling including optical or computer-readable identification labeling.

### BACKGROUND

The qualities of many products sold to consumers have a range of environmental conditions beyond which the product value is diminished by contamination, deterioration or exposure to unsuitable temperature conditions. For example, many foods will spoil if they are not kept within a certain temperature. Some products requiring refrigerated transport such as certain pharmaceuticals, if exposed to an environment beyond the acceptable temperature range, will lose the ability to perform or deliver the function that is expected. If the product is a perishable consumable such as a food item susceptible to microbial contamination, then the exposure to an undesirable temperature may render the consumable inedible or contaminated by microbial growth. Although a product is often marked with an expiration date, this date may not be an accurate indication of the item's freshness or usability. If the item is a temperature sensitive or perishable product that has been exposed to a temperature outside of its viable range, then the item will have “expired” prior to the marked expiration date. Generally, consumers expect that somewhere along the retail and production chain, a contaminated or expired product will be removed from distribution. However, due to the volume and quantity of distribution of some items, removal of contaminated, expired or undesirable products from commerce may not be an easy task due to cost and efficiency concerns.

There is no method currently available to automatically track and trace a product from its moment of manufacture or packaging until it reaches its final destination. There is also no method currently available to automatically track and trace an item that has been exposed to an undesirable environmental temperature. A rapid, accurate and cost-effective means of sensing an environmental change in temperature and identifying those products having a potentially compromised level of safety or usefulness to a consumer because of this exposure is of particular value to the food, retail and consumer regulatory industries. The present disclosure provides such advantages.

Unlike other methods, the present disclosure provides a device and system that allows rapid and early detection and automatic removal of a product that has been exposed to an undesirable environmental temperature. Use of the present disclosure will help to alert manufacturers, processors, distributors, public health officials and consumers of products that have experienced a break in the cold-chain distribution process and therefore, at increased likelihood of possessing microbial contamination or reduced product functionality. In addition, the present invention also provides useful archival data concerning such incidents.

The present disclosure also offers distributors and consumers an automatic means to continuously screen products susceptible to spoilage or reduced quality or effectiveness from the moment of packaging to the time of use by a consumer.

### BRIEF DESCRIPTION OF THE DRAWINGS

FIG. 1A depicts an example of device according to the present disclosure that has not been exposed to a preselected condition.

FIG. 1B depicts an example of device according to the present disclosure after the occurrence of a preselected condition.

FIG. 2 depicts an example of a device according to the present disclosure.

FIG. 3 depicts an example of a device according to the present disclosure.

### SUMMARY AND DESCRIPTION

The present disclosure provides a device for tracking and tracing a product or item's source and handling history. The present disclosure may, for instance, be applied to any product or item requiring or using cold chain distribution where a greater quality of freshness of a product is desired or where preventing distribution or removing from distribution of a product exposed to a preselected condition such as an undesirable environmental temperature is desired.

The present disclosure provides a device to identify an item that has been exposed to a predetermined or preselected condition and a method of tracking and tracing such an item, by the use of the device. The device comprising at least three components or three indicia, wherein at least one indicia or component of the device is identifiable or remains readable regardless of the presence or absence of a predetermined or preselected condition. Such a device can also include a second indicia which becomes identifiable or readable in the presence of a predetermined or preselected condition and a third indicia which becomes non-identifiable or nonreadable in the presence of the predetermined or preselected condition. The indicia may be identified or read by a conventional scanner, any optical scanner, computer or by a human. Such a multi-component device would include an “always readable” component which can include unique product identifying information, source of manufacturer, source of distributor, etc . . . or other identifying information that is of use in tracking and tracing the item; a “selectively readable” portion which is readable or enabled by the presence of a preselected condition; and a “selectively unreadable” which is unreadable or disabled by the presence of a preselected condition.

In one aspect of the present disclosure a method of identifying improper or undesirable handling of a product and/or tracking a product includes use of a device comprising at least three indicia wherein a first indicia is identifiable, a second indicia becomes identifiable or enabled by the presence of a preselected condition such as a preselected temperature, and a third indicia which becomes nonidentifiable or nonreadable or disabled by the presence of a preselected condition. A preselected condition can be any condition such as the presence of contamination, undesirable environmental temperature, improper handling, etc . . . For example, the present disclosure includes a product label or identifier for identifying and tracking the presence of exposure of a product to a preselected condition; the label comprising an always readable indicia (e.g. coded indicia), and a second indicia which becomes readable or enabled in the presence of the preselected condition. Such a device can also include an additional indicia which becomes unreadable or disabled when the second indicia becomes readable or enabled. Preselected conditions, include, for example, a temperature between of about 25 to about 200 degrees in Fahrenheit, or of about 30 to about 180 degrees in Fahrenheit, or about 40 to about 180 degrees in Fahrenheit or of about 40 degrees or above in Fahrenheit, of about 4 degrees or above in Celsius. Upon exposure of the device to a preselected condition, the thermo-sensitive indicator is activated such that its appearance changes to become readable by a scanner, computer or human identifying the product as having been exposed to the preselected condition.

One aspect of the present disclosure also provides a device to identify the presence of a preselected condition comprising a first computer readable indicia, a second indicia and an indicator associated with the second indicia such that the presence of a preselected condition activates the indicator so as to form an optically or computer readable code. Such a device includes, for example, a label such as a bar code label for authenticating and tracking a product. The label can comprise a first and a second indicia and at least one temperature-sensitive indicator wherein exposure of the indicator to a preselected temperature changes the appearance of the second indicia so as to be a computer readable indicia or a computer readable bar code. Such indicia can comprise those known in the art, for example, as RSS, UPC, JAN, EAN/UPC, GS1-128, ITF-14, Data Matrix, Composite Component, RRFID, RFID, or other identification, standard language system or platform provided locally, nationally, globally, or used by GS-1. Also included are indicia comprising human readable data combined with other readable indicia such as bar code data, RSS, UPC, EAN, RFID, etc., GILBAR™, or those comprising a component of the Food Sentinel System™.

Another aspect of the present disclosure is a device to identify a product that has been exposed to a predetermined or preselected condition thereby allowing for detection of its location during the distribution chain and need for removal from distribution. Such a device allows for distribution of products having improved integrity and safety as well as providing valuable product handling and archival data. Thus, the present disclosure provides a method to screen products from the time of packaging and during each phase of the product's distribution by integrating an indicator or indicia with presently available product bar codes. Activation of the indicator or indicia by presence of a preselected condition such as a preselected temperature renders one indicia, such as an item code unreadable and thus allows removal of the specific item from the distribution chain based on its identification by the appearance of the now readable condition code. If desired, an indicia which is identifiable in the presence or absence of the predetermined or preselected condition may be included, thereby allowing for detection of the product or item's source, manufacturer or other useful tracking information. Such tracking information can be any information that is desirable or useful to one skilled in the art by its remaining associated with the item throughout the item's manufacture, packaging, transport, distribution and/or use.

The present disclosure provides a method of identifying an item that has been exposed to a preselected condition by the use of a label comprising at least two coded indicia which are stored on separate bar codes and at least one condition indicator such that each coded indicia is exclusively readable within a specific temperature range, or by the use of a label comprising at least three indicia such that at least one indicia remains readable regardless of product handling or condition of the product.

A further aspect of the present disclosure is a method for tracking and tracing a product that has been exposed to a preselected condition such as an undesirable environmental temperature, using the device of the present disclosure. Use of the method provides effective and accurate monitoring and management of products in any type of distribution such as, for example, cold chain distribution thereby providing a means for increased supply chain security.

Such method and device allows for the automatic monitoring of a product's quality or safety to the consumer. Use of the device and method of the present disclosure allows identification of those items that have been exposed to an undesirable environmental temperature and at what point or location in the distribution chain there has been a break in the cold chain. The method includes a label affixed to each of a plurality of objects in commerce. The label is configured so as to include a first, second and third indicia wherein at least one indicia remains readable and able to provide product identifying information and a second indicia having an indicator such that the presence of a preselected condition renders the second indicia unreadable. Alternatively, the label is configured so as to include a first and a second indicia each indicia having at least one associated indicator such that the presence if a preselected condition activates the indicator(s) so as to render the first indicia non-computer readable and the second indicia computer readable. Such indicator(s) includes thermo-sensitive indicators such as those comprising thermochromic ink technology. Use of the method allows identification of those products or items that should be removed or culled from retail distribution. Therefore, the present disclosure also provides an automatic means for increasing the safety and quality of a product during all phases of its distribution chain.

The present disclosure also relates to a detection system associated with a multi-matrix or multi-bar code that includes coded indicia used to identify contaminated food. Such detection system includes coded indicia used to identify contamination in an environment or container, or exposure of a product to a preselected condition such as an environmental temperature indicative or associated with increased likelihood of contamination by microbial agents. The first indicia is identifiable and can include coded information so as to comprise a computer readable or optically readable indicia that includes a product identifier such as the product's type, source, brand name, quantity, price and the like. The second indicia is initially non-identifiable or non-computer readable and includes a thermo-sensitive indicator designed to identify the presence of exposure of the product to a preselected condition. Such a condition, includes, for example, a temperature between of about 25 to about 200 degrees in Fahrenheit or of about 30 to about 180 degrees in Fahrenheit, or about 40 to about 180 degrees in Fahrenheit or of about 40 degrees or above in Fahrenheit or of about 4 degrees or above in Celsius. Upon exposure of the indicator to a preselected condition, the thermo-sensitive indicator is activated such that its appearance changes to become a computer readable or optically readable indicia identifying the product as having been exposed to the preselected condition. Upon such identification, the product is targeted for removal or culling from the distribution chain. In addition, the location and time of occurrence of presence of such product is marked and archived.

The present disclosure provides a device and method including use with the Food Sentinel System™. The Food Sentinel System is an enhanced bar code format system which allows continuous monitoring for contamination of foods by pathogenic organisms. The system provides a method to track, trace and screen for products susceptible to contamination. By using germane portions of a product's identifying bar code as a test indicator, bar code readers or scanners at any station in processing or distribution are able to automatically reject a product that reflects a positive reading for contamination.

The Food Sentinel System™ which is described in further detail in U.S. patent Ser. No. 09/153,565, filed Sep. 15, 1998, utilizes a purveyor's barcode as a test indicator that will biochemically or environmentally physically “transform” itself into a new configuration. It then becomes a tamper-proof barcode formatted to interdict and report contaminated and/or temperature-abused food and pharmaceuticals with any barcode reader, at any station from processing to end-users. Relevant product displaying a positive reading for monitored contaminates will be automatically interdicted and reported, creating a permanent record in germane databases.

Rapid detection/screening methods, depending on target contamination, can be based on either enzyme, immunochemical or vapor/volatile technologies. Related to food monitoring, the disclosure provides a technology that enables time-and-temperature indicators to be directly produced on a substantially wide-range of common printing presses with Sentinel TTI barcodes imprinted on any label stock, poly bag, latex and most other materials. Integrating a TTI barcode onto a distribution or point-of-purchase, data-laden label is the quintessential response to the Federal Register report regarding desirability for TTI's that trace and are tamper-proof. Inasmuch as ranking management at the CDC and USDA attribute insufficient holding temperature and poor product handling to 73% of pathogenic food contamination, intentional abuse of holding temperatures could well become an unanticipated ubiquitous terrorist weapon.

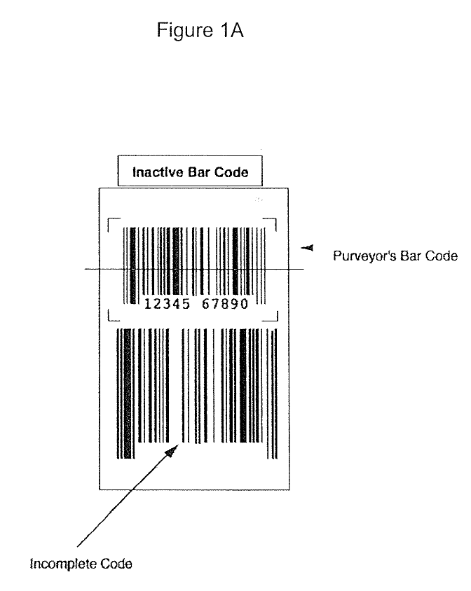

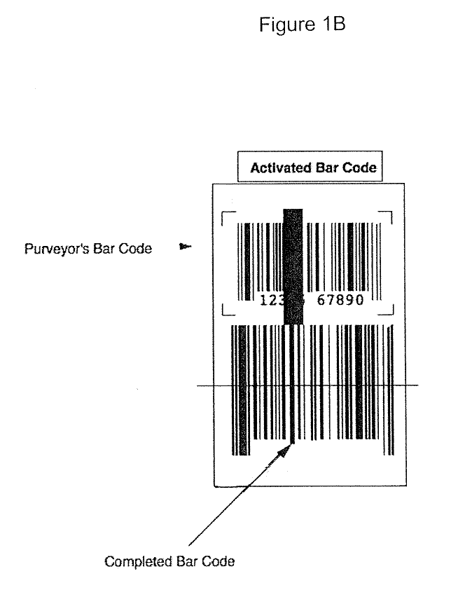

As depicted in FIG. 1, a device of the present disclosure includes a label 10 having a first coded indicia 20 and a second coded indicia 30 and at least one condition indicator 40. The first coded indicia 20 includes an identifiable or readable portion that provides the correct computer or optically readable SKU number when scanned by a conventional bar code scanner. The second coded indicia 30 comprises a non-readable indicia or incomplete code. As depicted in FIG. 1A, in the absence of a preselected condition, the indicator is present in a non-activated or non-visible state and is not computer readable or able to be read by a bar code scanner.

As depicted in FIG. 1B, in the presence of a preselected condition such as a temperature above a preselected value, the indicator is activated thereby altering the indicia such that it no longer comprises an optically readable indicia (e.g. “Purveyor Code”). Activation of the indicator alters the second indicia 30 to comprise an optically readable indicia 300 indicating the presence of a preselected condition—in this embodiment, may be a temperature above the desired range or value. One or more indicia or indicator may be associated with the first and/or second indicia or a single indicator may be provided. For example, for ease of manufacture of the device, an indicator may be one continuous linear symbol or may be two or more separate bars or lines; the configuration is largely immaterial provided that the presence of the preselected condition results in activation or alteration of the indicator(s) so as to render the first coded indicia non-readable and the second coded indicia readable. The term “optically readable” is intended to cover all indicia that can be recognized as such by optical scanning equipment such as scanners, cameras, lasers, etc. In one aspect of the present disclosure, an indicator may be used to detect exposure of the product to a preselected condition such as an environmental temperature of about 30 to about 180 degrees Fahrenheit or of about 40 degree Fahrenheit or above. Such an indicator can include, for example, a temperature-sensitive indicator comprising one or more thermochromic ink such as described in Lucht et al., U.S. Pat. No. 6,706,218 issued Mar. 16, 2004, Lucht et al., US Patent Application 20060098711 published May 11, 2006; Lucht et al., US Patent Application 20050104043 published May 19, 2005 or Cameron et al., U.S. Pat. No. 6,685,094. Thermochromic materials are substances which emit different colors at associated temperature ranges. Such materials include those which exhibit a one-time, permanent change in color as described in Lupton et al., U.S. Pat. No. 5,622,137 or may be reversible thermochromics as described in Shibahashi et al., U.S. Pat. No. 5,558,700 and Novinson U.S. Pat. No. 5,480,482. Alternatively, other means of temperature-sensitive indicators may be employed such as time-temperature indicators employing enzymatic processes which are described, for example, in Blixt et al., An Enzymatic Time/Temperature Device for Monitoring the Handling of Perishable Commodities, Dev. Biol. Stand., 36:237-41 (1976).

The present invention is not limited to devices wherein the indicia or three parts of the bar code consist of an original “two-part bar code” such as an RSS code with a CC component and indicator that switches on in the presence of improper handling. Instead this disclosure provides invention and methods that can be applied to any set of three code sections that are associated or indicia that are used together (collectively) in a scanning application, where in the preselected condition, one indicia remains readable, one is readable only if the product has been handled properly, and the third is readable only if the product has been mishandled or in the presence of the preselected condition.

In another aspect, the present disclosure is directed to a system for the automatic authenticating, and monitoring of a plurality of objects during all phases of the object's distribution in commerce using universally accepted coding standards.

The device of the present disclosure allows for the automatic removal or culling of a product that has been improperly handled or subject to a preselected condition. When a particular product such as a food item has been subjected to an improper temperature, the thermographic ink in the label causes an additional line to appear in the purveyor's code portion of the label with the condition code portion of the label gaining an additional line as well. Because the condition indicator has now changed the appearance of the second coded indicia to become the computer readable portion of the device, the product is now marked or tagged, and can be readily identified for removal from distribution. Where the product or item has been handled properly and has not been subjected to an undesirable temperature, the first coded indicia of the device will be read and the product will not be identified as having been exposed to mishandling or an improper temperature condition.

The present disclosure can be used with the Reduced Space Symbology (RSS) standard which is described at URL http://www.gs1.org/productssolutions/barcodes/technical/rss.html and http://www.gs1us.org/upc_background.html. The present disclosure can also be used with other standards such as the UPC, EAN, UCC-13 and GTIN standards as well as other automated identification and data capture (Auto-ID) methods such as, RFID, biometrics, magnetic stripes, OCR, smart cards and voice recognition.

The GS-1 global non-profit organization that designs and implements bar code standards has indicated Reduced Space Symbology (RSS) formats to be in place by 2010. This format allows for storing of more bar code data in a compact space, while offering a degree of straightforward upgradeability of users' bar code scanning equipment, internal firmware, and systems software. This will provide a number of benefits when implemented including the ability to embed information such as item sourcing information easily within the new codes, while still allowing conventional scanners to read the remainder of the data. The present disclosure is compatible (but not limited to use) with all RSS formats, such as, for example, RSS-14 Stacked, RSS Expanded Stacked, RSS Limited, RSS-14 Truncated, RSS-14 Stacked and others, which are described in further detail at URL http://www.gs1.org/productssolutions/barcodes/technical/bar_code_types.html.

Stacked RSS symbology variants, such as, for example, RSS-14 Stacked or RSS Expanded Stacked, will work in much the same way, with the additional bar code structure to enable the Food Sentinel monitoring capability displayed below the RSS “standard” codes, and with the thermographic ink structure to disable the RSS Stacked codes if the item has been exposed to an undesired condition.

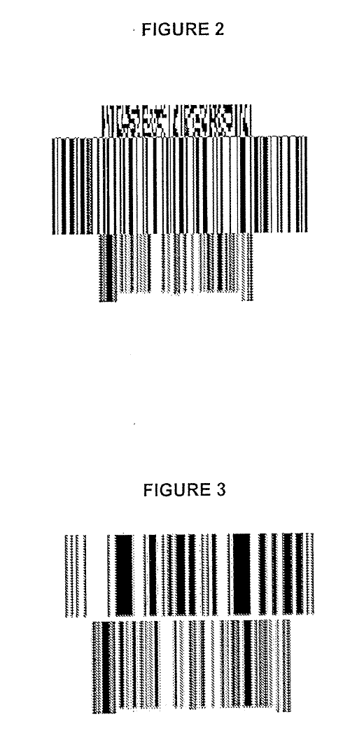

When the RSS symbology includes more data, such as using the Composite Component structures (such as the CC-A code as shown in FIG. 3), the present disclosure provides for a two-dimensional code structure with the CC structure always remaining active so that it is possible to always know an item's source and “tracking” information which would normally be embedded in such a PDF417-derived 2D structure. The “regular” or non-CC portions of the bar code or device would be disabled by at least one condition indicator such as an indicator comprising a thermographic ink, similar to the above described aspects. Technical specifications for Composite Component (CC) are available at URL: http://www.aimglobal.org/aimstore/adin include, CC-A, CC-B, and CC-C. Also included are, for example, RSS-14 Truncated with CC-A, RSS Limited™ with CC-B, GS1-12B (SSCC-18) with CC-C, EAN-13 with CC-A, EAN-8 with CC-A, UPC-A with CC-B, UPC-E with CC-A, GS1-128 (SCC-14) with CC-A, and GS 1-128 with CC-C. The present disclosure, therefore, also provides an easy and automatic method for tracking of an item source information through 2D data elements that are always “on” while identifying and stopping the item from being sold or delivered further on through the distribution process.

Use of the present disclosure with other symbologies such as the RSS and/or Composite Component structures, will include providing a paired bar code and printing structure so that if the product or item is stored improperly or has been exposed to a preselected condition or undesirable temperature, the label will be altered by the activation or thermal shift of at least one indicator or one or more condition indicator so that only a “do not sell” or “remove item from distribution” indicia is the working or readable portion of the device or label.

The present disclosure is applicable for use in shipping, distribution, retail or sales environments where a product such as food that has been damaged by temperature can be scanned, and the information identifying that damaged food was sourced from a specific vendor lot would be automatically “sent” back up into a central computer system. This tracking warning could then help identify other items of potential concern from the same lots, even if they have not yet been identified as damaged. It can also allow for sending information directly to the vendor for corrective action, all automated within the enterprise software of the retailer. In addition, a means of providing an archival database of such product incidents is provided by the present disclosure.

Bar code scanning can be done with hand-held devices or be automated as part of packaging, transportation, storage and retail operations. Scanners can be programmed to read the type of contamination, product and the date and location of the reading. In the absence of scanning devices, the consumer at home can observe the appearance of a new symbol on the bar code signaling contamination.

In another aspect of the disclosure, a product monitoring or tracking and tracing device is provided such that only a single “readable” bar code or product identifier is active at any one moment in time.

It is to be understood that both the foregoing general description are merely exemplary of the disclosure, and are intended to provide an overview or framework for understanding the nature and character of the disclosure as it is claimed. The accompanying drawings are included to provide a further understanding of the disclosure, and are incorporated in and constitute a part of this specification. The drawings illustrate various embodiments of the disclosure, and together with the description serve to explain the principles and operation of the disclosure. The present disclosure is not to be limited to the specific aspects shown which are merely illustrative. Various and numerous other embodiments and aspects may be devised by one skilled in the art without departing from the spirit and scope of the disclosure.

The scope of the disclosure is not limited to the detection of temperature conditions or of microbial contamination or the detection of such conditions in food. The device and method of the present disclosure may be employed in a variety of industries for the monitoring, tracking, tracing and/or archiving of various products or items in commerce. Including, but not limited to those provided via cold-chain distribution.

All articles, publications, references and patent citations provided herein, including referenced product or bar codes and symbols contained in various databases, in parentheses or otherwise, whether previously stated or not, are incorporated herein by reference in their entirety.

What is claimed:

1. A device comprising:
a first identifiable indicia;
a second indicia for becoming identifiable upon the occurrence of a predetermined condition; and
a third indicia.

2. The device of claim 1 wherein upon the occurrence of the predetermined condition, the third indicia is nonreadable.

3. The device of claim 1 further comprising at least one indicator that can be activated by the occurrence of the preselected condition to enable the identification of the second indicia and disable the identification of the third indicia.

4. The device of claim 1, wherein at least one of the indicia comprise optically-readable or computer-readable code.

5. The device of claim 1, wherein the indicator comprises a thermochromic ink responsive to the occurrence of the predetermined condition.

6. The device of claim 1, wherein the first indicia is identifiable by scanning equipment.

7. The device of claim 3, wherein upon activation the indicator renders the second indicia readable by scanning equipment and renders the third indicia unreadable by scanning equipment.

8. The device of claim 1 wherein the device is a label identifying a consumable product.

9. The device of claim 1 wherein the indicia comprise symbology selected from the group consisting of reduced space symbology (RSS), UPC, EAN, UCC-13, GTIN, RRFID, RFID, biometrics, magnetic stripes, OCR, smart cards and voice recognition.

10. The device of claim 1 wherein the predetermined condition is a preselected temperature.

11. The device of claim 10 wherein the preselected temperature is an environmental temperature of about 40 degrees Fahrenheit or above.

12. A product code device comprising:
a first readable indicia;
a second indicia reactive to a preselected temperature; and
at least one indicator, wherein in the presence of the preselected temperature the indicator is activated and the second indicia is then readable.

13. The product code device of claim 12 wherein the first readable indicia comprises a purveyor's code.

14. The product code device of claim 12 wherein in the presence of the preselected temperature, the second indicia is unreadable by a scanning device.

15. A method of monitoring the exposure of a product to a preselected condition, comprising:
applying at least one identifiable indicia to the product;
applying a second indicia to the product; and
applying a third indicia to the product, wherein in the presence of a predetermined condition, the second indicia is identifiable and the third indicia is nonidentifiable.

16. The method of claim 15, wherein at least one of the indicia comprises optically-readable code.

17. The method of claim 15 wherein at least one indicia comprises a thermochromic ink.

18. The method of claim 15 wherein the predetermined condition is a temperature of about 30 to about 180 degrees Fahrenheit.

19. The method of claim 18 wherein the predetermined condition is a temperature of above 40 degrees Fahrenheit.

20. The method of claim 15 wherein identification of the indicia comprises use of a bar code reader.

21. A method of identifying a product for removal from cold-chain distribution comprising use of the device of claim 1 or 12.

22. The method of claim 21 wherein use of the device of claim 1 or 12 provides archival data.
